(19) United States
(12) Patent Application Publication
(10) Pub. No.: US 2026/0296359 A1
(43) Pub. Date: Oct. 1, 2026

(54) AIRBAG DEVICE FOR DRIVER'S SEAT

(71) Applicants: Nissan Motor Co., Ltd., Yokohama-shi (JP); NIHON PLAST CO., LTD., Fujinomiya-shi (JP)

(72) Inventors: Mayumi SUZUKI, Kanagawa (JP); Yasushi ENARI, Kanagawa (JP); Yohei KIUCHI, Shizuoka (JP); Mio AKAIKE, Shizuoka (JP)

(21) Appl. No.: 19/630,569

(22) Filed: Mar. 27, 2026

(30) Foreign Application Priority Data
Mar. 31, 2025 (JP) 2025-057972

(51) Int. Cl. B60R 21/239; B60R 21/203; B60R 21/235

(52) U.S. Cl. CPC B60R 21/239; B60R 21/203; B60R 21/235; B60R 2021/23509

(57) ABSTRACT

An airbag device for a driver's seat includes an inflatable bag disposed at a center portion of a steering wheel to be deployed outwardly beyond a rim of the steering wheel at its deployment. Plural vent holes are formed on a front fabric of the inflatable bag that is disposed on the opposite side to the driver's seat. The vent holes are formed at a portion of the front fabric that is to be deployed outward beyond the rim. The vent holes include a center hole formed at a position directly above the center of the steering wheel, and a pair of first and second side holes respectively arranged on left and right sides of the center hole. An opening area of the center hole is larger than each opening area of the first and second side holes.

### CROSS REFERENCE TO RELATED APPLICATIONS

This application claims priority under 35 USC 119 to Japanese Patent Application No. 2025-057972, filed with the Japanese Patent Office on Mar. 31, 2025, the entire disclosure of Japanese Patent Application No. 2025-057972 is hereby incorporated herein by reference.

### TECHNICAL FIELD

The present invention relates to an airbag device for a driver's seat.

### BACKGROUND

Japanese Granted Patent Publication No. 3922086(JP3922086B2) discloses an airbag device for a driver's seat. The airbag device is installed at a center potion of a steering wheel. The airbag device includes an inflatable bag. On a front fabric of the inflatable bag, vent holes are formed for releasing inside gas during restraining of the driver in a frontal collision of a vehicle.

### SUMMARY

A reaction force experienced by a driver from an inflated airbag in a frontal collision may differ between a restraining mode where the driver is received by the inflated airbag on an orthogonal line passing though the center of the inflated airbag and another restraint mode where the driver is received by the inflated airbag while being off from the orthogonal line. If the two vent holes are formed on the airbag symmetrically on both left and right sides, it is concerned that the reaction force experienced by the driver may become inappropriate depending on the restraint modes of the airbag.

An object of the present invention is to provide an airbag device for a driver's seat that can generate an appropriate reaction force for a driver.

An airbag device for a driver's seat according to the present invention includes an inflatable bag disposed at a center portion of a steering wheel to be deployed outwardly beyond a rim of the steering wheel at its deployment. The inflatable bag has a rear fabric disposed on a driver side and a front fabric disposed on an opposite side to the driver side with respect to the rear fabric, and is provided with plural vent holes formed at a portion of the front fabric that is to be deployed outward beyond the rim. The plural vent holes include a center hole formed at a position directly above a center of the steering wheel, a first side hole arranged on one side from the center hole in a vehicle width direction to be distanced from the center hole, and a second side hole arranged on another side from the center hole in the vehicle width direction to be distanced from the center hole, and an opening area of the center hole is larger than each opening area of the first side hole and the second side hole.

According to the airbag device for a driver's seat, it is possible to generate an adequate reaction force for a driver.

### BRIEF DESCRIPTION OF DRAWINGS

Referring now to the attached drawings which form a part of this original disclosure, illustrative embodiments are shown.

FIG. 1 is a schematic drawing in which an airbag device for a driver's seat according to an embodiment is viewed from the front of a vehicle; and

FIG. 2 is a schematic front view showing relationship between an airbag main body and a rim of a steering wheel.

### DETAILED DESCRIPTION OF EMBODIMENTS

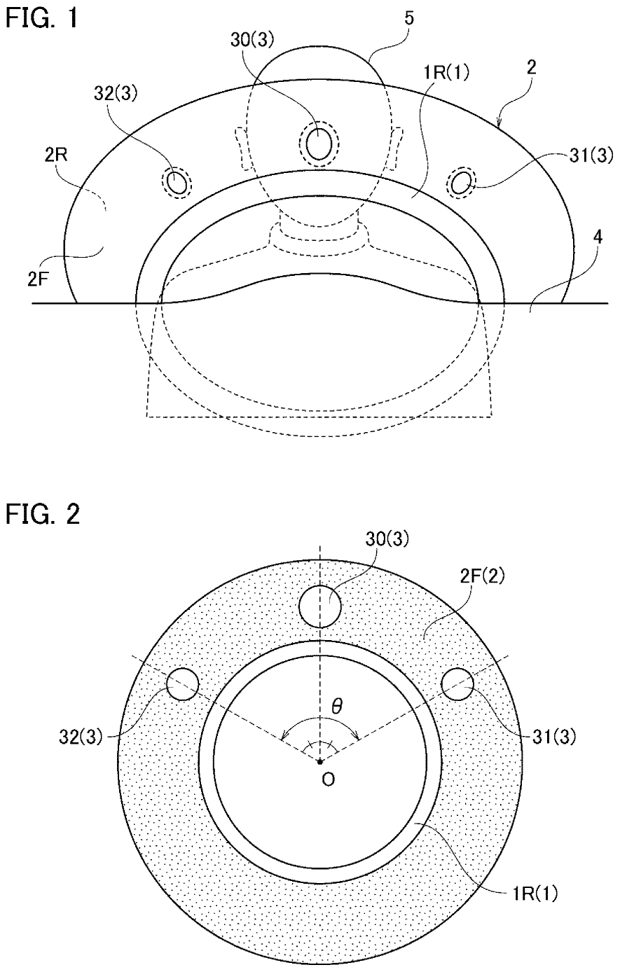

An airbag device for a driver's seat according to an embodiment will be described with reference to the drawings. FIG. 1 is a drawing in which a steering wheel 1 and an inflatable bag 2 of the airbag device are viewed from a front windshield side. A steering angle of the steering wheel 1 shown in FIG. 1 is zero degree for a straight forward running, and the inflatable bag 2 is fully developed. The inflatable bag 2 shown in FIG. 1 is in a state just before it receives a driver. FIG. 1 also shows three vent holes 3 of the inflatable bag 2 and an instrument panel 4.

The airbag device is installed at a boss located at the center of the steering wheel as an airbag module provided with an inflator (not shown in the drawings). The inflator will generate inflation gas when receiving an electrical trigger signal during a collision. The airbag device may be configured so that the airbag module also functions as a horn button.

The steering wheel 1 includes a boss plate (not shown in the drawings) provided with a boss that is attached to an end of a steering column (not shown in the drawings), spokes (not shown in the drawings) radially extended outward from the boss plate, and a ring-shaped rim 1R attached to radially-outer ends of the spokes. Note that only one spoke may be provided between the boss plate and the rim 1R. A plastic cover is attached to the boss plate, and the spokes and the rim are covered by formed resin or the like. Various switches may be embedded in the spokes.

The inflatable bag 2 is formed to have a bag shape by stitching two circular fabrics 2F and 2R together along their circumferential edges. Each of the fabrics 2F and 2R is made from a weaved cloth, and resin or rubber coating may be treated on an inside surface or an outer face of the bag. The two fabrics 2F and 2R are a rear fabric 2R positioned on a drive-side, i.e., on a rear side on a vehicle, and a front fabric 2F positioned on an opposite side to the driver-side with respect to the rear fabric 2R, i.e., on a front side of the vehicle. An opening (not shown in the drawings) is formed at the center of the front fabric 2F, and the inflatable bag 2 is attached to a base plate (not shown in the drawings) of the airbag module along an edge of this opening.

Note that the inflatable bag 2 formed by the two fabrics 2F and 2R circumferentially stitched together has been turned inside out by utilizing this opening, and a radially outside portion from the circumferential stitch line is located within the bag. In addition, an opening is also formed on the base plate to be associated with the opening of the front fabric 2F, and the inflator is installed to these openings. Furthermore, one or more tether belts may be provided within the bag in order to regulate the shape of the fully deployed inflatable bag 2, e.g., an axial inflation distance of the fully deployed inflatable bag 2.

The outer diameter of the inflatable bag 2 is sufficiently larger than the outer diameter of the rim 1R. Therefore, the outer diameter of the fully deployed inflatable bag 2 is larger than the outer diameter of the rim 1R. As shown in FIG. 1, the inflatable bag 2 is deployed outwardly beyond the rim 1R at its deployment, and the inflatable bag 2 that is inflated and receiving the driver is sustained by the rim 1R. The inflatable bag 2, which is inflated and receiving the driver, is also sustained by the spokes and sustained by the boss plate with the airbag module interposed therebetween.

In the embodiment, three vent holes 3 are formed on a portion of the front fabric 2F that is to be deployed outward beyond the rim 1R, i.e., in an area indicated by dot hatching in FIG. 2. The three vent holes 3 includes a center hole 30, a first side hole, 31 and a second side hole 32. The first side hole 31 is formed on one side of the center hole 30 in a vehicle width direction (left-right direction) to be distanced from the center hole 30. The second side hole 32 is formed on the other side of the center hole 30 in the lateral direction to be distanced from the center hole 30. An opening area of the center hole 30 is larger than an opening area of the first side hole 31 and is also larger than an opening area of the second side hole 32.

In the embodiment, the distance between the center hole 30 and the first side hole 31 is identical to the distance between the center hole 30 and the second side hole 32. In the embodiment, the opening area of the first side hole 31 is identical to the opening area of the second side hole 32. A ratio of each opening area of the first side hole 31 and the second side hole 32 with respect to the opening area of the center hole 30 is not less than 0.5 and not more than 0.9.

Next, the positions of the vent holes 3 relating to the steering wheel 1 will be explained with reference to FIG. 2. FIG. 2 can be regarded as a front or back view of the airbag device when directly facing to the rim 1R. In FIG. 2, relative positions of the rim 1R, the inflatable bag 2 and the vent holes 3 are shown schematically, and these are all shown by solid lines so that the relative positions can be recognized easily. Note that the inflatable bag 2 shown in FIG. 2 is in its fully deployed state.

In the embodiment, in the directly facing view of the rim 1R as shown in FIG. 2, the first side hole 31 and the second side hole 32 are arranged so that the central angle θ of the first side hole 31 and the second side hole 32 with respect to the center O of the steering wheel 1 is not less than 60 degrees and not more than 150 degrees. In addition, the center hole 30 is arranged on the bisector line of the central angle θ. This bisector line is on in the vertical plane when the steering wheel 1 is set to a steered angle for a straight forward running.

Note that the center O of the steering wheel 1 is the geometrical center of the ring-shaped rim 1R and doesn't always coincide with the rotational center of the steering wheel 1 and the center of the boss. Furthermore, in the above-mentioned directly facing view, the center of the deployed inflatable bag 2 doesn't always coincide with the center O of the steering wheel 1. In addition, the central angle θ is an angle between two lines defined by connecting the center O with two endpoints of an arc on a circumference of a circle with the center O. The two endpoints are defined by the first side hole 31 and the second side hole 32, respectively.

(1) The airbag device for a driver's seat includes the inflatable bag 2 disposed at a center portion of the steering wheel 1 to be deployed outwardly beyond the rim 1R of the steering wheel 1 at its deployment. The inflatable bag 2 has the rear fabric 2R disposed on the driver side, and the front fabric 2F disposed on the opposite side to the driver side with respect to the rear fabric 2R. The plural vent holes 3 are formed at a portion (shown by dot-hatchings in FIG. 2) of the front fabric 2F that is to be developed outward beyond the rim 1R. The plural vent holes 3 include a center hole 30 formed at the position directly above the center of the steering wheel 1, the first side hole 31 arranged on one side from the center hole 30 in the vehicle width direction to be distanced from the center hole 30, and the second side hole 32 arranged on the other side from the center hole 30 in the vehicle width direction to be distanced from the center hole 30. The opening area of the center hole 30 is larger than each opening area of the first side hole 31 and the second side hole 32.

When the driver is received directly by the deployed inflatable bag 2 without offset to the left or right, the inflatable bag 2 receives the driver along the orthogonal line passing through its center. In other words, the driver is received at the center portion of the inflatable bag 2, and the inflatable bag 2 itself is received by the whole circumference of the rim 1R, the spokes and the boss. According to the above configuration, the inflatable bag 2 is crushed along with the forwarding motion of the driver received by the center portion of the inflatable bag 2, the inside gas in the inflatable bag 2 is instantaneously released from the center hole 30 with the larger opening area. Therefore, it is restricted for the driver from receiving an excessive reaction force, and the deployed inflatable bag 2 can generate an appropriate reaction force for the driver.

In the event of a collision at the front corner of the vehicle, the driver is not propelled straight forward by the inertial force of the impact and received by the inflatable bag 2 obliquely. Specifically, when the driver is received by the inflatable bag 2 offset to the left or right, the driver is received not at the center portion of the inflatable bag 2 but received biasedly to the left or right side, and the inflatable bag 2 is also received by the rim 1R biasedly to the left or right side. In such cases, if the inside gas in the inflatable bag 2 is released too instantaneously, the inflatable bag 2 deflates before sufficiently restraining the driver. According to the above configuration, the inflatable bag 2 is partially crushed along with the obliquely forwarding motion of the driver, the inside gas in the inflatable bag 2 is released steadily from the first side hole 31 or the second side hole 32 each with the smaller opening area. Therefore, the inflatable bag 2 is restricted from deflating too quickly, and the deployed inflatable bag 2 can generate an appropriate reaction force for the driver.

(2) According to the embodiment, in the directly facing view of the rim 1R, the central angle θ of the first side hole 31 and the second side hole 32 with respect to the center O of the steering wheel 1 is not less than 60 degrees and not more than 150 degrees. In addition, the center hole 30 is disposed on the bisector line of the central angle θ.

The inflatable bag 2 primarily receives the driver's head within the upper half from its center portion. When the central angle θ is less than 60 degrees, the three vent holes 3 become too close together and thereby the inside gas is released too rapidly when the inflatable bag 2 receives the driver at its center portion. In such cases, it is concerned that the resulting reaction force becomes lower than the appropriate reaction force. Furthermore, when the inflatable bag 2 receives the driver biasedly to the left or right side, the inside gas release is delayed. In such cases, it is concerned that the resulting reaction force becomes higher than the appropriate reaction force.

When the central angle θ exceeds 150 degrees, the positions of the first side hole 31 and the second side hole 32 become lower. Consequently, when the inflatable bag 2 receives the driver biasedly to the left or right side, the inside gas release is delayed. In such cases, it is concerned that the resulting reaction force becomes higher than the appropriate reaction force. Therefore, it is preferable to arrange the vent holes 3 such that the central angle θ is not less than 60 degrees and not more than 150 degrees.

(3) According to the embodiment, the opening area of the first side hole 31 and the opening area of the second side hole 32 are identical to each other. In addition, the ratio of each opening area of the first side hole 31 and the second side hole 32 with respect to the opening area of the center hole 30 is not less than 0.5 and not more than 0.9.

If the ratio is less than 0.5, the first side hole 31 and the second side hole 32 are too small for the appropriate size of the center hole 30. Therefore, when the inflatable bag 2 receives the driver biasedly to the left or right side, the inside gas release from the first side hole 31 or the second side hole 32 is delayed. In such cases, it is concerned that the resulting reaction force becomes higher than the appropriate reaction force. If the ratio is less than 0.5, the center hole 30 is too large for the respective appropriate size of the first side hole 31 and the second side hole 32. Therefore, when the inflatable bag 2 receives the driver at its center portion, the inside gas is released from the center hole 30 too rapidly. In such cases, it is concerned that the resulting reaction force becomes lower than the appropriate reaction force.

If the ratio is more than 0.9, the difference between the size of the center hole 30 and the size of the first side hole 31 and the second side hole 32 becomes small. Therefore, in a case where the size of the center hole 30 is appropriate, when the inflatable bag 2 receives the driver biasedly to the left or right side, the inside gas is released from the first side hole 31 or the second side hole 32 too rapidly. In such cases, it is concerned that the resulting reaction force becomes lower than the appropriate reaction force. In a case where the size of the first side hole 31 and the second side hole 32 is appropriate, when the inflatable bag 2 receives the driver at its center portion, the inside gas is released from the center hole 30 is delayed. In such cases, it is concerned that the resulting reaction force becomes higher than the appropriate reaction force. Therefore, it is preferable that the above-mentioned ratio is not less than 0.5 and not more than 0.9.

The embodiment of the present invention has been described above, but the descriptions and drawings forming part of this disclosure should not be understood as limiting the invention. Various alternative embodiments, examples, and operational techniques will be apparent to a person skilled in the art from this disclosure.

What is claimed is:

1. An airbag device for a driver's seat, the device comprising:
an inflatable bag disposed at a center portion of a steering wheel to be deployed outwardly beyond a rim of the steering wheel at a deployment thereof,
wherein the inflatable bag has a rear fabric disposed on a driver side, and a front fabric disposed on an opposite side to the driver side with respect to the rear fabric,
wherein a plurality of vent holes is formed at a portion of the front fabric that is to be deployed outward beyond the rim,
wherein the plurality of vent holes comprises a center hole formed at a position directly above a center of the steering wheel, a first side hole arranged on one side from the center hole in a vehicle width direction to be distanced from the center hole, and a second side hole arranged on another side from the center hole in the vehicle width direction to be distanced from the center hole, and
wherein an opening area of the center hole is larger than each opening area of the first side hole and the second side hole.

2. The airbag device for a driver's seat according to claim 1, wherein
in a directly facing view of the rim, a central angle of the first side hole and the second side hole with respect to the center of the steering wheel is not less than 60 degrees and not more than 150 degrees, and the center hole is disposed on a bisector line of the central angle.

3. The airbag device for a driver's seat according to claim 1, wherein
the opening area of the first side hole and the opening area of the second side hole are identical to each other, and
a ratio of each opening area of the first side hole and the second side hole with respect to the opening area of the center hole is not less than 0.5 and not more than 0.9.
